(19) United States
(12) Patent Application Publication
(10) Pub. No.: US 2025/0384527 A1
(43) Pub. Date: Dec. 18, 2025

(54) LOCAL TONE MAPPING USING A NEURAL-NETWORK-GENERATED LUMINANCE COMPENSATION GAIN MAP

(71) Applicants: ADVANCED MICRO DEVICES, INC., Santa Clara, CA (US); ATI TECHNOLOGIES ULC, Markham (CA)

(72) Inventors: Yi-Hsun Cheng, Santa Clara, CA (US); Rastislav Lukac, San Jose, CA (US); William Lloyd Atkinson, Markham (CA)

(21) Appl. No.: 18/746,966

(22) Filed: Jun. 18, 2024

(51) Int. Cl. G06T 5/60; G06T 1/20

(52) U.S. Cl. CPC G06T 5/60; G06T 1/20; G06T 2207/20081; G06T 2207/20084

(57) ABSTRACT

To generate a compensation map used to enhance a captured image, an accelerator unit (AU) is configured to implement a trained neural network. This trained neural network is configured to encode one or more lighting characteristics from the capture image and decode these lighting characteristics into a compensation map. The AU uses the compensation map generated by the trained neural network to modify at least a portion of the captured image to produce an enhanced image. Then, the AU applies one or more additional postprocessing techniques to further improve quality of the enhanced image prior to rendering the enhanced image on a display.

### BACKGROUND

Some processing systems execute applications, such as video conferencing applications, streaming applications, photo applications, and the like, that require digital images captured by a camera to be presented to a user. However, when the camera captures a scene without deliberate illumination, the resulting digital image or video often does not meet desired imaging or aesthetic objectives due to varying brightness or luminance characteristics within regions of the captured scene. This disparity in luminance between regions or within regions of the digital image causes groups of pixels of the digital image to have different levels of contrast. Having these different levels of contrast between groups of pixels increases the likelihood that one or more portions of the digital image appear underdefined, blurry, washed out, obscured, or the like, which negatively impacts the visual fidelity and perception of images.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system including an accelerator unit (AU) implementing a trained neural network configured to generate a luminance compensation gain map, in accordance with some embodiments.

FIG. 2 is a block diagram of an example trained neural network configured to generate a luminance compensation gain map, in accordance with some embodiments.

FIG. 3 is a flow diagram of an example operation for modifying the values of a captured frame based on a luminance compensation gain map, in accordance with some embodiments.

FIG. 4 is a block diagram of an example training operation for a neural network configured to generate a luminance compensation gain map, in accordance with some embodiments.

FIG. 5 is a flow diagram of an example postprocessing operation using a neural-network-generated luminance compensation gain map, in accordance with some embodiments.

FIG. 6 is a flow diagram of an example method for producing an enhanced image using a neural-network-generated luminance compensation gain map, in accordance with some embodiments.

### DETAILED DESCRIPTION

Systems and techniques disclosed herein include a processing system configured to execute applications configured to display one or more captured images to a user such as videoconference applications, video calling applications, streaming applications, camera applications, and the like. For example, a capture device (e.g., camera) included in or otherwise connected to the processing system is configured to capture one or more frames representing images, video, or both. After capturing such frames, the capture device provides data representing the captured frames to an accelerator unit (AU) of the processing system. The AU then processes the data and renders the captured frames on a display such that the captured frames are presented to the user. As an example, the capture device provides encoded data representing one or more captured frames to the AU of the processing system. The AU then decodes the encoded data representing the captured frames and renders one or more frames based on the decoded data such that the captured frames are presented to the user. However, when the capture device captures an image or video under certain lighting conditions, without deliberate illumination, or both, one or more resulting captured frames each include one or more regions, groups of pixels, or both that have varying brightness, luminance, or other characteristics. These disparities of characteristics between regions or within regions of the digital image cause groups of pixels within the digital image to have different levels of brightness, contrast, or noise, to name a few. Due to these differing levels within groups of pixels, the likelihood that one or more portions of the digital image appear underdefined, blurry, washed out, obscured, or the like, is increased, which negatively impacts the visual fidelity and perception of captured images.

To this end, systems and techniques disclosed herein are directed to enhancing the quality of a captured image using a neural-network-generated luminance compensation gain map. For example, the AU of the processing system is configured to implement a trained neural network configured to receive data representing a captured frame (e.g., captured image or video frame) as an input and generate a luminance compensation gain map (e.g., a compensation map) as an output. Such a luminance compensation gain map, for example, includes one or more values (e.g., weights, gains) to enhance (e.g., tone map) one or more pixels of the captured image. To generate such a luminance compensation gain map, the AU provides data representing the capture frame to a neural network configured to generate a luminance compensation gain map. For example, based on receiving data representing the captured frame, the AU downsamples the data representing the captured frame to a first predetermined resolution and then provides the downsampled data to the trained neural network configured.

This trained neural network, for example, includes an encoding-decoding neural network architecture configured to encode data representing a captured frame into an encoded latent representation of the lighting characteristics (e.g., luminance gain values) of the captured frame. The trained neural network then decodes this latent representation to produce a luminance gain map used to enhance the captured image. For example, the trained neural network includes multiple encoding layers each configured to encode (e.g., convolute) received data at a corresponding scale to produce a respective scaled representation of the lighting characteristics of the captured frame. For example, the trained neural network includes a first encoding layer configured to encode the data representing the captured image to produce a first representation of the lighting characteristics of the captured frame at a first scale. Further, the trained neural network includes a second encoding layer configured to encode a first representation of the lighting characteristics of the captured frame to produce a second representation of the lighting characteristics of the captured frame at a second scale and a third encoding layer configured to encode the second representation of the lighting characteristics of the captured frame to produce a third representation of the lighting characteristics of the captured frame at a third scale. Additionally, the trained neural network includes one or more decoder layers each configured to decode (e.g., deconvolute) received data at a corresponding scale to produce a respective feature map of the captured image representing the lighting characteristics of the captured image. For example, a first decoder layer is configured to decode the encoded latent representation of the lighting characteristics of the captured frame at a first scale to produce a first feature map, and a second decoder layer is configured to decode the first feature map at a second scale to produce a second feature map. After a decoder layer decodes a feature map at a scale equal to the scale of the data representing the captured image in the input to the first encoder layer, the trained neural network produces a multichannel feature map representing the lighting characteristics of the captured image.

To help reduce estimation errors in the latent representation of the lighting characteristics (e.g., luminance gain values) of the captured frame, the trained neural network includes a residual block that includes one or more convolutional layers and is disposed between the encoder and the decoder. As an example, the residual block includes a first convolutional layer configured to receive the latent representation of the lighting characteristics as an input and generate (e.g., based on one or more weights) a modified representation of the lighting characteristics at the same resolution as the latent representation as an output. This modified representation of the lighting characteristics is then provided to a second convolutional layer which produces a second modified representation of the lighting characteristics at the same resolution as the latent representation. The residual block then continues in this way until a final convolutional layer of the residual block outputs a corresponding modified representation of the lighting characteristics at the same resolution as the latent representation. This output from the final convolutional layer is then provided to the decoder. Additionally, to help ensure that the neural network with multiple layers is effectively trained, the residual block includes respective skip connections between the inputs and outputs of one or more corresponding convolutional layers.

After generating the multichannel feature map, the trained neural network is configured to produce a single-channel feature map. For example, the neural network further includes an averaging layer configured to average the luminance gain values of the multichannel feature map to generate a single feature value in each pixel location. Additionally, the trained neural network includes a modulation layer configured to normalize and map a single feature value to a desired range to produce a luminance compensation gain map. Once the neural network has generated the luminance compensation gain map, the AU modifies one or more pixels of the captured image based on the luminance compensation gain map to produce an enhanced (e.g., tone-mapped) image. For example, to produce an enhanced image, the AU converts the data representing the captured frame to the linear domain to produce linear luminance values associated with the captured image. The AU then modifies these linear luminance values based on the generated luminance compensation gain map (e.g., an upscaled version of the luminance compensation gain map) to produce one or more modified luminance values.

Additionally, the AU performs one or more postprocessing techniques on the modified luminance values to, for example, help reduce the likelihood of visual artifacts (e.g., flicker) in a resulting enhanced image. For example, to improve the processing efficiency, the AU first downsamples the modified luminance values associated with the captured image to a predetermined resolution and determines one or more statistical profiles of the modified luminance values. As an example, the AU determines one or more reference points, including median values, dark points, light points, or the like for one or more groups of values of the modified luminance values. Based on these reference points, the AU segments a range (e.g., luminance range) associated with the modified luminance values into one or more subranges with each subrange associated with a corresponding pixel enhancement function (e.g., gamma correction, tone mapping, histogram equalization, contrast enhancement, noise masking). Each pixel enhancement function associated with a subrange is defined by a respective set of values such as a gain value, offset value, gamma value, or the like. For example, a first subrange is associated with a first pixel enhancement (e.g., gamma correction) as defined by a first set of values, and a second subrange is associated with a second pixel enhancement (e.g., gamma correction) as defined by a second set of values different from the first set of values. Based on a modified luminance value falling within a respective subrange, the AU applies a corresponding pixel enhancement to the pixel associated with the modified luminance value to modify the color components of the pixel, the luminance value of the pixel, or both. After applying a corresponding pixel enhancement to one or more pixels associated with the modified luminance values, the AU produces an enhanced image which is then stored in a memory, rendered on a display, or both.

Modifying the luminance values of the captured image based on the luminance compensation gain map in this way helps reduce the difference in levels (e.g., brightness, contrast, or noise levels) between groups of pixels within the image which, in turn, helps reduce the portions of the captured image that appear underdefined, blurry, washed out, obscured, or the like. As such, the visual fidelity of the captured image is improved, also helping to improve camera user experience. Additionally, because a trained neural network is used to generate the luminance compensation gain map rather than traditional methods that are computationally sophisticated and slow, the time and processing resources needed to generate a quality luminance compensation gain map and the enhanced image are reduced, thus improving the overall computational efficiency of the processing system.

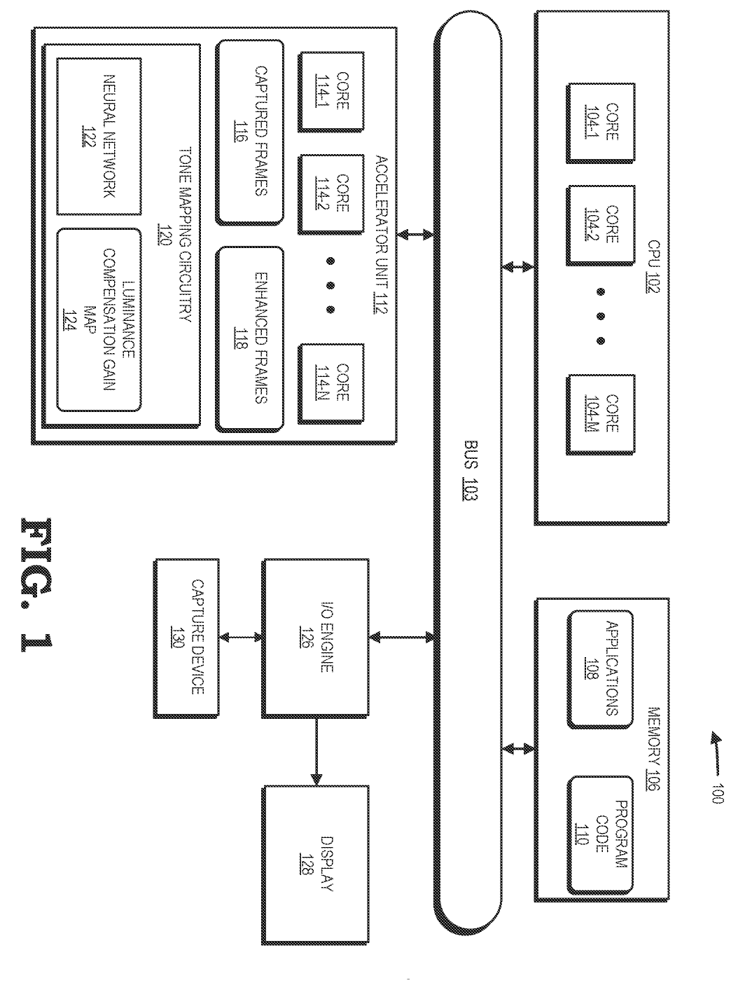

Referring now to FIG. 1, a processing system 100 including an AU implementing a trained neural network configured to generate a luminance compensation gain map is presented, in accordance with some implementations. In implementations, processing system 100 is implemented within one or more servers, databases, cloud-based devices, personal computers, laptops, drones, mobile devices, or the like and includes or has access to memory 106 or other storage components implemented using a non-transitory computer-readable medium, for example, a dynamic random-access memory (DRAM). In some implementations, memory 106 is implemented using other types of memory including, for example, static random-access memory (SRAM), nonvolatile RAM, and the like. Further, memory 106, according to some implementations, includes an external memory to the processing units implemented in the processing system 100. The processing system 100 also includes a bus 103 to support communication between components (e.g., CPU 102, AU 112, memory 106) implemented in the processing system 100. Some implementations of processing system 100 include other buses, bridges, switches, routers, and the like, which are not shown in FIG. 1 in the interest of clarity. For example, in some implementations, processing system 100 includes a data fabric that includes bus 103 and that is configured to support communication between the components of processing system 100.

According to implementations, processing system 100 is configured to execute one or more applications 108 configured to present one or more captured frames 116 to a user. Such applications 108, for example, include videoconferencing applications, streaming applications, video calling applications, camera applications, and the like. To help processing system 100 in executing these applications 108, processing system 100 includes or is otherwise connected to (e.g., via one or more networks) a capture device 130. A capture device 130, for example, includes circuitry configured to capture images, video, or both. As an example, a capture device 130 includes a camera, such as digital single-lens reflex (DSLR) camera, smartphone camera, web camera, camcorder, video camera, surveillance camera, laptop camera, or the like, to name a few. According to implementations, the capture device 130 is configured to capture one or more frames (e.g., captured frames 116) representing at least a portion of an environment surrounding the capture device 130. For example, a captured frame 116 includes data indicating pixel values (e.g., RGB values) that represent at least a portion of the environment and lighting conditions viewed by the capture device 130. After capturing one or more captured frames 116, in implementations, capture device 130 provides the captured frames 116 to one or more elements of processing system 100. As an example, in some implementations, capture device 130 is configured to encode one or more captured frames 116 based on one or more reference frames and based on one or more codecs (e.g., H.264, HEVC, VP9, AV1). Capture device 130 then transmits the encoded captured frames 116 over one or more networks (not shown for clarity) to processing system 100 which then provides the encoded captured frames 116 to AU 112.

According to implementations, processing system 100 is configured to display the captured frames 116 from capture device 130 on a display 128, store captured frames 116 in memory 106 or other storage, or both. As such, processing system 100 includes AU 112 configured to render one or more captured frames 116 on display 128. AU 112, for example, is configured to operate as one or more vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (e.g., field-programmable gate arrays (FPGAs)), or any combination thereof. In implementations, AU 112 performs one or more commands, instructions, draw calls, or any combination thereof indicated in an application 108 to display one or more captured frames 116 on display 128, store one or more captured frames in memory 106 or another storage, or both. To perform commands, instructions, draw calls, or any combination thereof for one or more applications 108, AU 112 implements a plurality of processor cores 114-1, 114-2, 114-N that execute instructions concurrently or in parallel. In some implementations, one or more of the processor cores 114 each operate as one or more compute units (e.g., single instruction, multiple data (SIMD) units) that perform the same operation on different data sets. Though in the example implementation illustrated in FIG. 1, AU 112 includes three processor cores (114-1, 114-2, 114-N) representing an N number of cores, the number of processor cores 114 implemented in AU 112 is a matter of design choice. As such, in other implementations, AU 112 can include any number of processor cores 114. In embodiments, the processor cores 114 execute instructions based on program code 110 (e.g., machine-learning code, neural network code, image processing code) stored in memory 106, and AU 112 stores data, such as the results of the executed instructions, in memory 106.

In implementations, AU 112 is configured to first decode one or more encoded captured frames 116 from capture device 130 before rendering the captured frames 116 on display 128, storing the captured frames 116 in memory 106 or another storage, or both. As such, AU 112 includes decoding circuitry (not pictured for clarity) configured to decode the encoded captured frames 116 from capture device 130 based on one or more reference frames and one or more codecs (e.g., H.264, HEVC, VP9, AV1) to produce one or more captured frames 116. In some other implementations, AU 112 is configured to receive captured frames 116 from capture device 130 as raw data (e.g., the output of an image sensor not shown here for clarity), or some other data generated from raw data by executing image processing code 110 stored in memory 106. After obtaining captured frames 116, AU 112 renders the captured frames 116 on display 128, stored the decoded frame in memory 106 or another storage, or both. However, due to certain lighting conditions in the environment surrounding capture device 130, one or more captured frames 116 captured by capture device 130 include one or more regions with varying brightness or luminance characteristics compared to one or more other regions of the captured frame 116. Because of this disparity in luminance between regions or even within regions of the captured frame 116, the captured frame 116 includes one of more group of pixels which have different levels of brightness and contrast than other groups of pixels, causing one or more portions of the captured frame 116 to be underdefined, blurry, washed out, obscured, or the like and negatively impact the visual fidelity and perception of the captured frame 116.

To help reduce these brightness and contrast differences between groups of pixels, AU 112 includes a tone mapping circuitry 120 that is configured to modify one or more pixel values of the captured frame 116 based on a luminance compensation gain map 124 (e.g., a compensation map). Such a luminance compensation gain map 124, for example, includes data indicating one or more respective values (e.g., gains, compensation factors, mapping indices) to apply to corresponding pixel values of the captured frame 116 to reduce the brightness and contrast differences between groups of pixels. To generate this luminance compensation gain map 124, tone mapping circuitry 120 includes a trained neural network 122 configured to receive data representing a captured frame 116 as an input and to generate a luminance compensation gain map 124 as an output. As an example, in implementations, tone mapping circuitry 120 first downsamples a captured frame 116 (e.g., data representing a captured frame 116) to one or more predetermined resolutions. Tone mapping circuitry 120 then provides the downsampled captured frame 116 (e.g., downsampled image) to the trained neural network 122 configured to generate a luminance compensation gain map 124 or a corresponding feature map which comprises at least one channel that includes data representing one or more luminance gain values for each pixel of the downsampled captured frame 116. In some implementations, trained neural network 122 generates a multichannel feature map that includes luminance gain values (e.g., compensation values) obtained for different predetermined resolutions of the captured frame 116.

To generate such a feature map (e.g., multichannel feature map), the neural network 122 includes one or more encoder layers (e.g., an encoder) trained to extract lighting characteristics by encoding data representing the captured frame 116 into a latent representation of the lighting characteristics of the captured frame 116 at a predetermined scale. Each encoder layer of the trained neural network 122 includes circuitry configured to encode (e.g., convolute) received data at a corresponding scale to produce a respective scaled representation of the luminance gain values of the captured frame. For example, the trained neural network 122 includes a first encoding layer having circuitry configured to encode data representing the captured frame 116 to produce a first representation of the luminance gain values of the captured frame 116 at a first scale. Further, the trained neural network 122 includes a second encoding layer having circuitry configured to encode the first representation of the luminance gain values of the captured frame 116 to produce a second representation of the luminance gain values of the captured frame 116 at a second scale, different from (e.g., smaller than) the first scale. Additionally, in implementations, the trained neural network 122 includes a third encoding layer having circuitry configured to encode the second representation of the luminance gain values of the captured frame 116 to produce a third representation of the luminance values of the captured frame 116 at a third scale, different from (e.g., smaller than) the first scale and the second scale. In implementations, the trained neural network 122 includes any number of encoding layers necessary to encode a representation of the luminance gain values of the captured frame 116 at the predetermined scales of the latent representation. Additionally, the trained neural network 122 is configured to reconstruct luminance gain values from the latent representation of the luminance gain values of the captured frame 116 generated by the encoding layers. The trained neural network 122 includes one or more decoder layers each configured to decode (e.g., deconvolute) received data at a corresponding scale to produce a respective feature map representing the luminance gain values of one or more pixels of the captured frame 116. As an example, the trained neural network 122 includes a first decoder layer having circuitry configured to decode the latent representation at a predetermined scale of the lighting characteristics of the captured frame at a first scale to produce a first feature map and includes a second decoder layer having circuitry configured to decode the first feature map at a second scale to produce a second feature map. After a decoder layer decodes a feature map at a first predetermined scale equal to the scale of the data representing captured frame 116 provided to the trained neural network 122, the trained neural network 122 produces a multichannel feature map representing one or more luminance gain values for each pixel of the captured frame 116 (e.g., including two or more compensation values for each pixel of the captured frame 116).

Further, to help reduce errors in the latent representation, the trained neural network 122 also includes a residual block disposed between the encoder and the decoder. Such a residual block, in implementations, includes one or more convolutional layers that receive data at the resolution of the latent representation of the lighting characteristics of the captured frame 116 and output data at the same resolution. As an example, the residual block includes a first convolutional layer configured to receive the latent representation of the lighting characteristics of the captured frame 116 from the encoder and to output, based on one or more corresponding weights, a modified representation of the lighting characteristics at the same resolution. This modified representation of the lighting characteristics is then provided to a second convolutional layer which produces, based on corresponding weights, a second modified representation of the lighting characteristics again at the same resolution. The residual block then continues in this way until a final convolutional layer of the residual block outputs a corresponding modified representation of the lighting characteristics at the same resolution as the latent representation. The output from this final convolutional layer is then provided to the decoder which generates the multichannel feature map. Further, according to implementations, the residual block also includes respective skip connections between the input and output of one or more convolutional layers. These skip layers, for example, allow training errors to be backpropagated in the residual block and keep the training of the neural network with multiple layers (e.g., deep neural network) effective.

After generating the multichannel feature map, the trained neural network 122 is configured to convert the multichannel feature map to a single-channel luminance gain map representing a single luminance gain value for each pixel of the captured frame 116 at a predetermined resolution. To generate the single-channel luminance gain map, the trained neural network 122 also includes an averaging layer including circuitry configured to average the luminance gain values for each pixel represented by the multichannel feature map to produce a single luminance gain value per pixel. Further, the trained neural network 122 includes a modulation layer (e.g., exponential layer) having circuitry configured to map these luminance gain values to a target range to produce a luminance compensation gain map 124 (e.g., a compensation map). According to some implementations, the luminance compensation gain map 124 has a resolution equal to the data representing the captured frame 116 provided to a first encoder layer while in other implementations the resolution of luminance compensation gain map differs from that of the data representing the captured frame 116 provided to a first encoded layer.

In implementations, after the trained neural network 122 has generated the luminance compensation gain map 124, the tone mapping circuitry 120 is configured to modify one or more pixel values of a captured frame 116 based on the luminance compensation gain map 124 to produce an enhanced frame 118. To modify one or more pixel values of a captured frame 116 based on a luminance compensation gain map 124, tone mapping circuitry 120 first performs gamma decoding (e.g., inverse gamma correction) on the captured frame 116. As an example, based on a predetermined gamma value, tone mapping circuitry 120 transforms the luminance values of the pixels of the captured frame 116 from a gamma space to a linear space. Further, to modify one or more pixel values of a captured frame 116 based on a luminance compensation gain map 124, tone mapping circuitry 120 resizes the luminance compensation gain map 124 (e.g., resizes a compensation map) to match the resolution of the captured frame 116. Tone mapping circuitry 120 then applies the resized luminance compensation gain map 124 (e.g., resized compensation map) to the captured frame 116 to correct and enhance its appearance. For example, tone mapping circuitry 120 multiplies the gamma-decoded luminance values by corresponding luminance compensation gain values from the resized luminance compensation gain map 124 to produce a compensated frame. In some implementations, the luminance compensation gain map is applied to all channels of the captured frame 116 while in other implementations, the luminance compensation gain map is applied to an extracted luminance, lightness, or brightness component of one or more pixels of the captured frame 116. In some other implementations, tone mapping circuitry 120 performs one or more color transforms of one or more pixels of the captured frame 116 to enhance the brightness, lightness, or some other component of the pixels in a transformed color space (e.g., International Commission on Illumination (CIE)LAB; CIELUV; hue, saturation, value (HSV); hue, saturation, lightness (HSL)). For example, tone mapping circuitry 120 is configured to transform pixel values to a new color space to perform enhancement (e.g., gain compensation) on one or more transformed pixel components and perform an inverse transform of the enhanced pixel values back to the original color space.

According to implementations, tone mapping circuitry 120 is configured to further refine the compensated frame to produce an enhanced frame 118. As an example, in implementations, tone mapping circuitry 120 is configured to refine the compensated frame to reduce visual artifacts (e.g., flicker) in a resulting enhanced frame 118. As an example, tone mapping circuitry 120 is configured to first downscale the compensated frame to a predetermined resolution. The tone mapping circuitry 120 then performs one or more operations (e.g., statistics collection operations) to determine and analyze a statistical profile of the downscaled compensated frame. For example, based on the luminance values of one or more groups of pixels of the downscaled compensated frame, the tone mapping circuitry 120 determines one or more reference values, such as median luminance values, dark point values, bright point values, or the like. In some implementations, tone mapping circuitry 120 is configured to perform temporal filtering (e.g., weighted averaging of reference values along a time axis, weighted averaging of captured frames along a time axis, or both) to stabilize the reference values from one frame to another. According to some other implementations, tone mapping circuitry applies temporal filtering to the luminance compensation gain map 124 or other values instead or in addition to the reference values. Based on these reference values, tone mapping circuitry 120 segments the luminance range of the pixels of the downscaled compensated frame into two or more subranges each associated with a corresponding pixel enhancement function (e.g., gamma correction, tone mapping, histogram equalization, contrast enhancement, and noise masking). Such pixel enhancement functions, for example, are defined to adjust one or more pixels using a gain value, offset value, gamma value, or the like. In some embodiments, the values defining pixel enhancement functions are predetermined while in other embodiments, the tone mapping circuit 120 is configured to dynamically determine these values for each determined subrange. Based on the subrange associated with the luminance value of a pixel (e.g., the respective subrange within which the luminance value is located), the tone mapping circuitry 120 then applies a corresponding pixel enhancement function to the pixel to modify the color components of the pixel, the luminance value of the pixel, or both. In some implementations, the pixel enhancement function involves one or more color transforms to modify the brightness, lightness, or some other component of a pixel in a transformed color space (e.g., CIELAB, CIELUV, HSV, HSL).

As an example, based on the luminance value of a first pixel being in a first subrange, tone mapping circuitry 120 is configured to apply a first pixel enhancement function defined by a first set of values to modify the color components of the first pixel, the luminance value of the first pixel, or both. Further, based on the luminance value of a second pixel being in a second subrange, tone mapping circuitry 120 is configured to apply a second pixel enhancement function defined by a second set of values, different from the first set of values, to modify the color components of the second pixel, the luminance value of the second pixel, or both. According to some embodiments, the tone mapping circuitry 120 is configured to generate one or more look-up tables to apply a corresponding pixel enhancement to one or more pixels. For example, based on the set of values defining a first pixel enhancement, the tone mapping circuitry 120 generates a look-up table that applies the first pixel enhancement based on a respective luminance value of a pixel. Additionally, in some embodiments, the tone mapping circuitry 120 is configured to perform a color temperature adjustment on the compensated frame as modified by the pixel enhancements to generate an enhanced frame 118.

By modifying the pixel values of the captured frame 116 based on the luminance compensation gain map 124 in this way, the brightness and contrast differences between groups of pixels within the resulting enhanced frame 118 are reduced, helping to reduce the number of portions of the enhanced frame 118 that appear underdefined, blurry, washed out, obscured, or the like. As such, the visual fidelity of the captured frame 116 is increased in the resulting enhanced frame 118, helping to also improve the quality of the frame as well as user experience. Further, because the luminance compensation gain map 124 is obtained using the trained neural network 122, the time and processing resources needed to generate the luminance compensation gain map 124 are reduced when compared to traditional techniques. By reducing the time needed to generate the luminance compensation gain map 124, the time needed to produce an enhanced frame 118 is also reduced, helping to improve the processing efficiency of the processing system 100.

In implementations, the processing system 100 also includes a central processing unit (CPU) 102 that is connected to the bus 103 and therefore communicates with the AU 112 and the memory 106 via the bus 103. The CPU 102 implements a plurality of processor cores 104-1 to 104-M that execute instructions concurrently or in parallel. In implementations, one or more of the processor cores 104 operate as SIMD units that perform the same operation on different data sets. Though in the example implementation illustrated in FIG. 1, three processor cores (104-1, 104-2, 104-M) are presented representing an M number of cores, the number of processor cores 104 implemented in the CPU 102 is a matter of design choice. As such, in other implementations, the CPU 102 can include any number of processor cores 104. In some implementations, the CPU 102 and AU 112 have an equal number of processor cores 104, 114 while in other implementations, the CPU 102 and AU 112 have a different number of processor cores 104, 114. The processor cores 104 execute instructions such as program code 110 for one or more applications 108 stored in the memory 106 and the CPU 102 stores information in the memory 106 such as the results of the executed instructions. The CPU 102 is also able to initiate video and image processing by issuing instructions to AU 112. According to implementations, processing system 100 also includes an input/output (I/O) engine 126 that includes circuitry configured to handle input or output operations associated with the display 128, capture device 130, an external storage device as well as other elements of the processing system 100 such as keyboards, mice, printers, external storages, and the like. The I/O engine 126 is coupled to the bus 103 so that the I/O engine 126 communicates with the memory 106, AU 112, CPU 102, or any combination thereof.

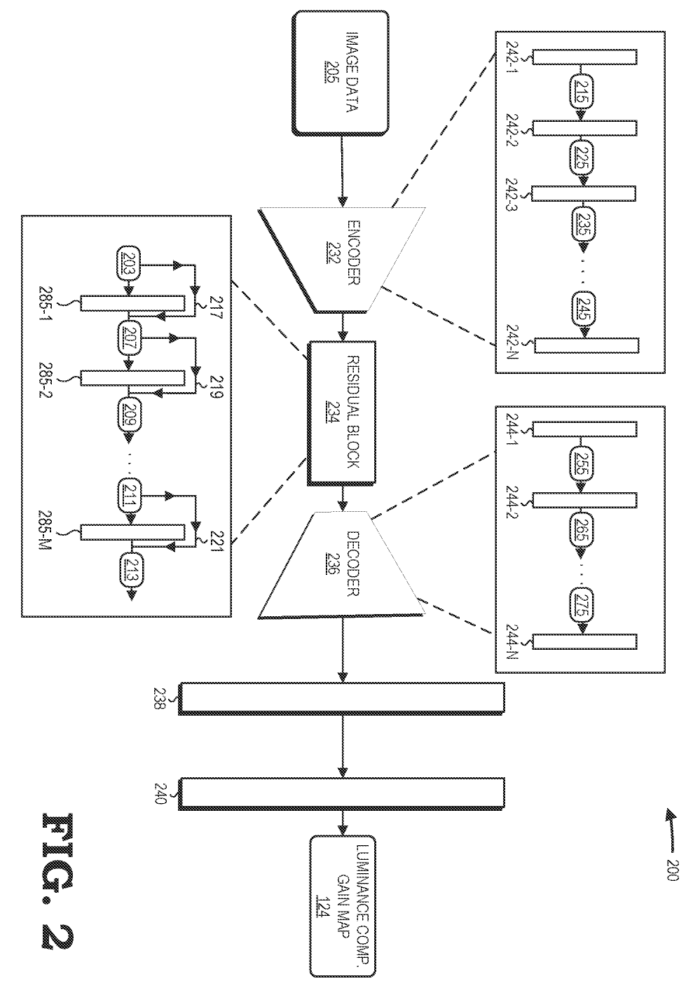

Referring now to FIG. 2, an example trained neural network 200 configured to generate a luminance compensation gain map is presented, in accordance with some implementations. In implementations, example trained neural network 200 is implemented in processing system 100 as trained neural network 122. According to implementations, example trained neural network 200 includes an encoder 232 configured to receive image data 205. Image data 205 includes, for example, data representing a captured frame 116 from capture device 130. According to some implementations, image data 205 includes data representing a captured frame 116 downsampled to a predetermined resolution. In implementations, encoder 232 is configured to generate a latent representation 203 of the luminance gain values of image data 205. For example, encoder 232 includes encoder layers 242 each including circuitry configured to generate an encoded representation of received data at a corresponding predetermined encoding scale to produce luminance compensation gain values based on the received data. As an example, based on receiving an input (e.g., data), each encoder layer 242 performs one or more convolution operations to generate an encoded representation (215, 225, 235, 245) of the input at a predetermined encoding scale that represents luminance compensation gains of the image data 205 at the predetermined encoding scale. In implementations, one or more encoder layers 242 are each configured to output data (e.g., encoded representation of a received input) as the input to a subsequent encoder layer 242.

Referring to the example embodiment presented in FIG. 2, a first encoder layer 242-1 is configured to encode the downsampled image data 205 to produce a first encoded representation 215 that represents luminance gain compensation values of a captured frame 116 at a first predetermined encoding scale. Additionally, the first encoder layer 242 is configured to provide the first encoded representation 215 to a second encoder layer 242-2 as an input. The second encoder layer 242 is configured to encode the first encoded representation 215 to produce a second encoded representation 225 that represents luminance gain compensation values of a captured frame 116 at a second predetermined encoding scale different from (e.g., smaller than) the first predetermined encoding scale. The second encoder layer 242-2 is also configured to provide the second encoded representation 225 to a third encoder layer 242-3 as an input. The third encoder layer 242-3 is configured to encode the second encoded representation 225 to produce a third encoded representation 235 that represents luminance gain compensation values of a captured frame 116 at a third predetermined encoding scale different from (e.g., smaller than) the first and second predetermined encoding scales. Additionally, the encoder includes a final encoder layer 242-N configured to receive an encoded representation 245 from a previous encoder layer (e.g., the encoder layer 242 immediately preceding the final encoder layer 242-N). The encoded representation 245, for example, is at a fourth predetermined encoding scale different from (e.g., smaller than) the first, second, and third predetermined encoding scales and represents luminance gain compensation values of a captured frame 116 at the fourth predetermined encoding scale. The final encoder layer 242 is configured to encode the fourth encoded representation 245 to produce the latent representation 203. This latent representation 203, for example, includes data representing the luminance gain compensation values of a captured frame 116 at a predetermined scale different from (e.g., smaller than) the encoding scales of the encoded representations 215, 225, 235, 245 produced by the encoder layers 242. Though the example embodiment presented in FIG. 2 shows the encoder 232 as including four encoder layers 242-1, 242-2, 242-3, 242-N representing an N number of encoder layers, in other embodiments, encoder 232 can include any number of encoder layers 242.

In some embodiments, example trained neural network 200 includes a residual block 234 disposed between encoder 232 and decoder 236. Residual block 234, for example, includes circuitry configured to implement one or more convolutional layers 285. Though the example embodiment presented in FIG. 2 shows residual block 234 as including three convolutional layers (285-1, 285-2, 285-M) representing an M number of convolutional layers, in other embodiments, residual block 234 may include any number of convolutional layers 285. In embodiments, residual block 234 is configured to receive latent representation 203 and output a modified representation 213 based on one or more convolutional layers 285. Each of these convolutional layers 285, for example, is configured to apply one or more weights to received data at a certain scale to produce an output at the same certain scale. For example, in the example embodiment of FIG. 2, residual block 234 includes a first convolutional layer 285-1 configured to receive latent representation 203 as an input. The first convolutional layer 285-1 then applies one or more corresponding weights (e.g., as determined by the parameters of example trained neural network 200) to latent representation 203 to produce an output at the same resolution as latent representation 203. Additionally, to help improve network learning capabilities without increasing the number parameters and operations, the residual block 234 includes a first skip connection 217 that provides the input of the first convolutional layer 285-1 (e.g., latent representation 203) to combine it with the data output by the first convolutional layer 285-1. The combination of the data output by the first convolutional layer 285-1 and the input of the first convolutional layer 285-1 (e.g., latent representation 203) produces a first modified representation 207 at the same scale as latent representation 203.

Additionally, residual block 234 includes a second convolutional layer 285-2 of residual block 234 that receives the first modified representation 207 as an input. The second convolutional layer 285-2 then applies one or more corresponding weights to the first modified representation 207 to produce an output at the same resolution as the first modified representation 207. Further, residual block 234 includes a second skip connection 219 that provides the input of the second convolutional layer 285-2 (e.g., first modified representation 207) to combine it with the data output by the second convolutional layer 285-2 to produce a second modified representation 209 at the same scale as the first modified representation 207. In embodiments, residual block 234 includes a final convolutional layer 285-M configured to receive a third modified representation 211 from a previous convolutional layer 285 (e.g., the convolutional layer 285 immediately preceding the final convolutional layer 285-M). The final convolutional layer 285-M then applies one or more corresponding weights to the third modified representation 211 to output data at the same scale as the third modified representation 211. According to embodiments, residual block 234 also includes a third skip connection 221 configured to provide the input of the final convolutional layer 285-M (e.g., third modified representation 211) to combine it with the output of the final convolutional layer 285-M to produce a modified latent representation 213 at the same scale as latent representation 203.

According to implementations, example trained neural network 200 includes decoder 236 configured to reconstruct the luminance gain compensation values of the image data 205 based on modified latent representation 213. To this end, decoder 236 includes decoder layers 244 each including circuitry configured to decode received data to a corresponding predetermined decode scale to reconstruct luminance compensation gain values from received data. For example, based on receiving an input (e.g., data), each decoder layer 244 performs one or more deconvolution operations to decode the input to a predetermined decoding scale to produce a feature map (255, 265, 275) representing reconstructed luminance compensation gain values of the input at the predetermined decoding scales. In implementations, one or more decoder layers 244 are each configured to output data (e.g., feature map) as an input to a subsequent decoder layer.

Within the embodiment presented in FIG. 2, as an example, a first decoder layer 244-1 is configured to decode the modified latent representation 213 to produce a first feature map 255 representing reconstructed luminance gain compensation values of a captured frame 116 at a first predetermined decode scale. Further, the first decoder layer 244 is configured to provide the first feature map 255 to a second decoder layer 244-2 as an input. The second decoder layer 244-2 is configured to decode the first feature map 255 to produce a second feature map 265 representing reconstructed luminance compensation gain values of a captured frame 116 at a second predetermined decode scale different from (e.g., greater than) the first predetermined decode scale. The second decoder layer 244-2 is also configured to provide the second feature map 265 to a third decoder layer (not shown for clarity). Additionally, the decoder 236 includes a final decoder layer 244-N configured to receive a feature map 275 from a previous decoder layer (e.g., the decoder layer immediately preceding the final decoder layer 244-N). The feature map 275, for example, has a third predetermined decode scale different from (e.g., greater than) the first, and second predetermined decode scales and represents reconstructed luminance compensation gain values of a captured frame 116 at the third predetermined decode scale. The final decoder layer 244-N is configured to decode the third feature map 275 to produce a feature map representing reconstructed luminance compensation gain values (e.g., reconstructed compensation values) of a captured frame 116 at a final decode scale. The decoder 236 is further configured to combine two or more feature maps from various decode stages to produce a multichannel feature map. Such a multichannel map, for example, includes two or more reconstructed luminance compensation gain values (e.g., two or more reconstructed compensation values) for one or more pixels of the input image data 205. Though the example embodiment presented in FIG. 2 shows the decoder 236 as including three decoder layers 244-1, 244-2, 244-N representing an N number of decoder layers, in other embodiments, decoder 236 can include any number of decoder layers 244.

In implementations, decoder 236 is configured to provide the multichannel feature map representing two or more reconstructed luminance compensation gain values for one or more pixels of the downsampled image data 205 to an averaging layer 238. The averaging layer 238 is configured to, for one or more pixels of the multichannel feature map, combine (e.g., average) two or more luminance compensation gain values (e.g., two or more compensation values) each associated with the pixel of interest to produce a single luminance gain compensation value associated with this pixel. By combining the luminance gain compensation values of the pixel represented by the multichannel feature map in this way, averaging layer 238 produces a single compensation gain value in each pixel location (e.g., produces a single-channel feature map). Then, averaging layer 238 provides this single-channel feature map to a modulation layer 240, which is configured, for example, to implement one or more exponential operations, sigmoidal operations, or the like to enhance and map the intermediate luminance compensation gain values to a desired range to produce the luminance compensation gain map 124 (e.g., a compensation gain map).

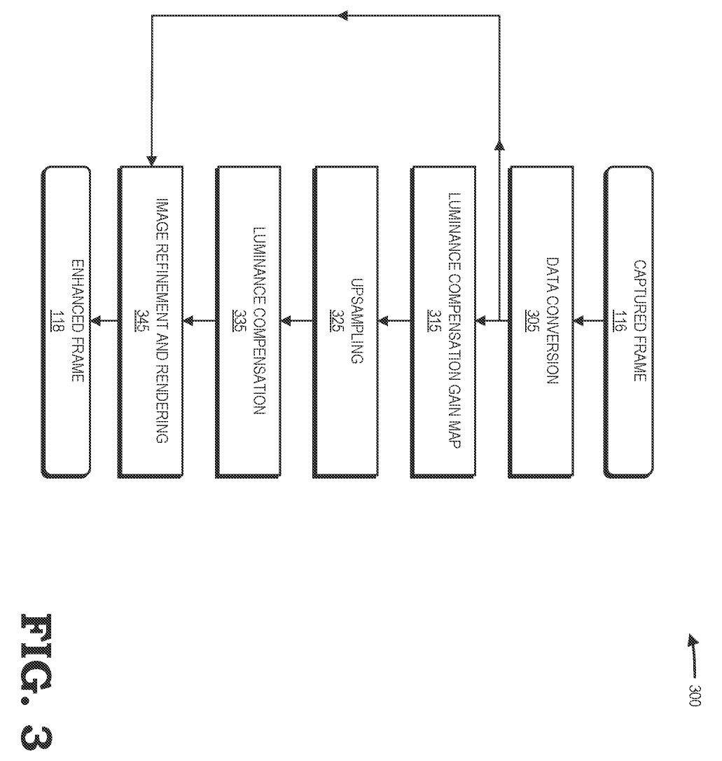

Referring now to FIG. 3, an example operation 300 for modifying the values of a captured frame based on a luminance compensation gain map is presented, in accordance with some implementations. According to implementations, example operation 300 is implemented by AU 112. In embodiments, example operation 300 includes AU 112 receiving a captured frame 116 from, for example, capture device 130. Further, example operation 300 includes data conversion block 305, during which, AU 112 is configured to convert captured frame 116 from a first data type to a second data type usable by trained neural network 122. For example, AU 112 converts data representing the captured frame from integer representation to a floating-point format usable by trained neural network 122. Further, in some embodiments, AU 112, at block 305, downsamples the converted data representing the captured frame to a predetermined resolution. At luminance compensation gain map 315, for example, AU 112 provides the data representing captured frame 116 to a trained neural network (e.g., trained neural network 122, 200) configured to generate luminance compensation gain values (e.g., compensation values) to perform image enhancement. As an example, the trained neural network includes an encoder (e.g., encoder 232) configured to encode the downsampled captured frame into a latent representation (e.g., latent representation 203) of the luminance compensation gain values of the downsampled captured frame. Further, the trained neural network includes a residual block (e.g., residual block 234) configured to modify the latent representation to produce a modified latent representation (e.g., modified latent representation 213). Additionally, the trained neural network includes a decoder (e.g., decoder 236) that decodes the modified latent represents to produce a multichannel feature map representing luminance compensation gain values (e.g., compensation values) for one or more pixels of the captured frame downsampled at different scales.

Still referring to the luminance compensation gain map 315, the trained neural network is further configured to, for each pixel of the downsampled captured frame, combine (e.g., average) the luminance compensation gain values associated with the pixel to produce a single luminance compensation gain value for each pixel of the captured frame (e.g., in averaging layer 238). The trained neural network then adjusts the luminance compensation gain values via a modulation function (e.g., mapping by modulation layer 240) to produce a luminance compensation gain map 124 for the captured frame. After the neural network has generated the luminance compensation gain map 124, at upsampling 325, AU 112 is configured to resize (e.g., upscale) the generated luminance compensation gain map 124 to the resolution of the captured frame 116. At the luminance compensation 335, AU 112 (e.g., tone mapping circuitry 120) modifies one or more pixel values of the captured frame 116 (e.g., the converted captured frame) based on the luminance compensation gain map 124 to produce a compensated frame. For example, AU 112 modifies a pixel value of the converted captured frame by multiplying the pixel value by a corresponding value in the luminance compensation gain map 124 to produce a compensated frame. After AU 112 has produced the compensated frame, example operation 300 includes image refinement and rendering block 345, during which, AU 112 is configured to convert one or more pixels of the compensated frame to a linear domain (e.g., by performing inverse gamma correction). Further, at block 345, AU 112 is configured to, based on a statistical analysis of the luminance values of the pixels of the compensated frame, determine one or more subranges of the luminance range of the compensated frame. Based on the subranges associated with each pixel of the compensated frame, AU 112 applies a corresponding pixel enhancement to the pixel to modify the color component of the pixel, the luminance value of the pixel, or both. After these respective pixel enhancements are applied to the pixels, AU 112 produces enhanced frame 118.

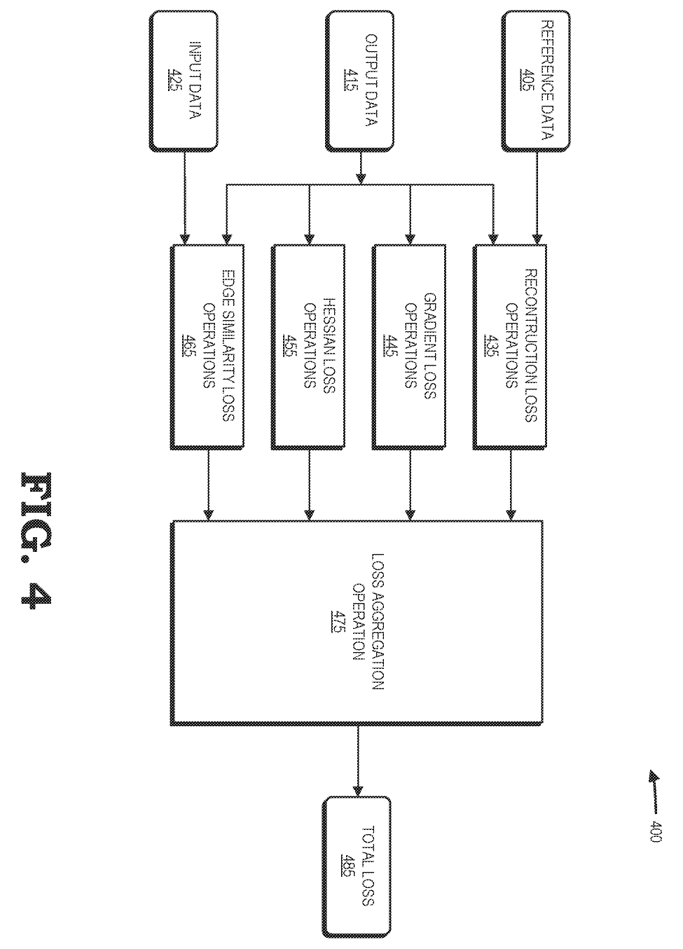

Referring now to FIG. 4, an example training operation 400 for a neural network configured to generate a luminance compensation gain map is presented, in accordance with implementations. In implementations, example training operation 400 is implemented by processing system 100 to train neural networks 122, 200. According to implementations, example training operation 400 includes one or more reconstruction loss operations 435, gradient loss operations 445, Hessian loss operations 455, edge similarity loss operations 465, loss aggregation operations 475, or any combination thereof, to name a few. For example, in implementations, example training operation 400 first includes processing system 100 providing a frame (represented in FIG. 4 as input data 425) to a trained neural network 122, 200. The trained neural network 122, 200 then generates one or more luminance compensation gain maps 124 (e.g., represented in FIG. 4 as output data 415) based on the input data 425 as described above with reference to FIGS. 1-3. For example, the trained neural network 122, 200 uses respective sets of parameters (e.g., weights, biases) to generate corresponding luminance compensation gain maps 124 (e.g., compensation maps) from input data 425. Additionally, example training operation 400 includes processing system 100 (e.g., CPU 102, AU 112) generating reference data 405. Such reference data 405, for example, includes a ground-truth reference (e.g., data used to train neural networks) that represents a target frame (e.g., reference image) for the trained neural network 122, 200 during the training process. In implementations, this target frame (e.g., reference image), for example, is determined by processing system 100 combining two or more frames each representing the environment as represented by the input data 425. For example, in implementations, processing system 100 is configured to determine a first frame based on input data 425 from a first source such that the first frame represents a foreground of the environment. Further, processing system 100 is configured to determine a second frame based on input data 425 from a second source such that the second frame represents the background of the environment. Processing system 100 then determines respective luminance compensation gain maps for the first and second frames by, for example, performing data analysis and luminance estimation (e.g., Retinex decomposition) on these frames.

After determining respective luminance compensation gain maps for the first and second frames, processing system 100 is configured to combine the luminance compensation gain maps to produce reference data 405. Further, in some implementations, processing system 100 is configured to modify one or more pixel values of the first frame, the second frame, or both to induce one or more image artifacts in a combination of the first frame and the second frame. Such artifacts include, for example, one or more of halo effects, high-frequency artifacts, and some other effects in a combined image. In this way, processing system 100 generates reference data 405 that represents luminance compensation gain maps for images having different artifacts and subsequently train a neural network 122, 200 to compensate for these artifacts when generating luminance compensation gain maps.

According to implementations, example training operation 400 includes one or more reconstruction loss operations 435. Each reconstruction loss operation 435, for example, includes processing system 100 (e.g., CPU 102, AU 112) first comparing output data 415 (e.g., a luminance compensation gain map generated based on input data 425) as generated by a corresponding set of parameters to reference data 405 (e.g., one or more luminance compensation gain maps). For example, a reconstruction loss operation 435 includes comparing the luminance gain values of reference data 405 and the luminance gain values of output data 415 as generated by a corresponding set of parameters to determine a value representing an amount of reconstruction loss. After processing system 100 determines multiple loss values each representing an amount of reconstruction loss between the luminance gain values of output data 415 as generated by a corresponding set of parameters and the luminance values of reference data 405, processing system 100, in some embodiments, combines (e.g., via weighted averaging) the values together to determine a total reconstruction loss value.

Additionally, example training operation 400 includes gradient loss operations 445 executed by processing system 100 to determine the rate of change in horizontal and vertical directions in the output data 415 (e.g., a luminance gain map 124) to help prevent high-frequency artifacts in the output data 415. As an example, based on the training data used to train the trained neural network 122, 200, using lower loss values indicated by the reconstruction loss operations 435 to modify the parameters of trained neural network 122, 200 increases the likelihood that the trained neural network 122, 200 produces output data 415 with undesired high-frequency contents, leading to artifacts in a compensated image produced using the output data 415. However, including the gradient loss operations 445 in example training operation 400 helps ensure that these undesired high frequencies are not introduced into the output data 415 while still minimizing the total loss of the output data 415. Additionally, example training 400 includes Hessian loss operations 455 to measure the second derivative of the output data 415. By adding the Hessian loss 455 to the training agent 400, the trained neural network learns to suppress halo artifacts in the compensated images (and model output) by seeking lower Hessian loss while competing with other loss operations (e.g., reconstruction loss operations 435, gradient loss operations 445, edge similarity loss operations 465).

Further, in some embodiments, example training operation 400 includes one or more edge similarity loss operations 465 configured to help restore edges in output data 415. For example, reconstruction loss operations 435, gradient loss operations 445, and Hessian loss operations 455 are not aimed at maintaining edge information indicated in input data 425 when the trained neural network 122, 200 produces output data 425. Due to this, the likelihood that one or more edges indicated in the input data 425 are lost (e.g., not preserved) in the output data 425 is increased. Such edges, for example, include a difference in luminance gain values between two or more pixels of an image that represents the edge or outline of an object within the frame. To help maintain these edges in output data 415, processing system 100 performs one or more edge detection techniques (e.g., using gradients, zero crossings, moments, and frequency analysis) to determine edge information in the input data 425. Additionally, processing system 100, using one or more edge detection techniques, identifies one or more edges in the luminance gain compensation map of output data 415 as generated by a corresponding set of parameters. Processing system 100, using edge similarity loss operations 465, then compares the identified edges in input data 425 to the edges in the output data 415 to generate an edge loss value representing an amount of loss (e.g., difference) between the edges in the input data 425 and the output data 415 as generated by a corresponding set of parameters.

To help optimize the neural network, example training operation 400 first generates output data 415 using a first set of parameters for trained neural network 122, 200. Based on the output data 415 generated using the first set of parameters, reconstruction loss operations 435 then produces a reconstruction loss value. Additionally, based on the first set of parameters, gradient loss operations 445 produces a gradient loss value, Hessian loss operations 455 produces a Hessian loss value, and edge similarity loss operations 465 produces an edge loss value. The processing system 100 then performs a loss aggregation operation 475 by assigning corresponding predetermined weights to the reconstruction loss value, gradient loss value, Hessian loss value, and edge loss value to combine these loss values to produce total loss 485 which represents an amount of loss for the set of parameters used to generate output data 415. The processing system 100 then repeats this process using different parameters to generate output data 415 subject to minimizing total loss 485. For example, the processing system 100 continues to use different parameters to generate output data 415 until total loss 485 is equal to or less than a predetermined threshold value or until some other convergence criteria are met.

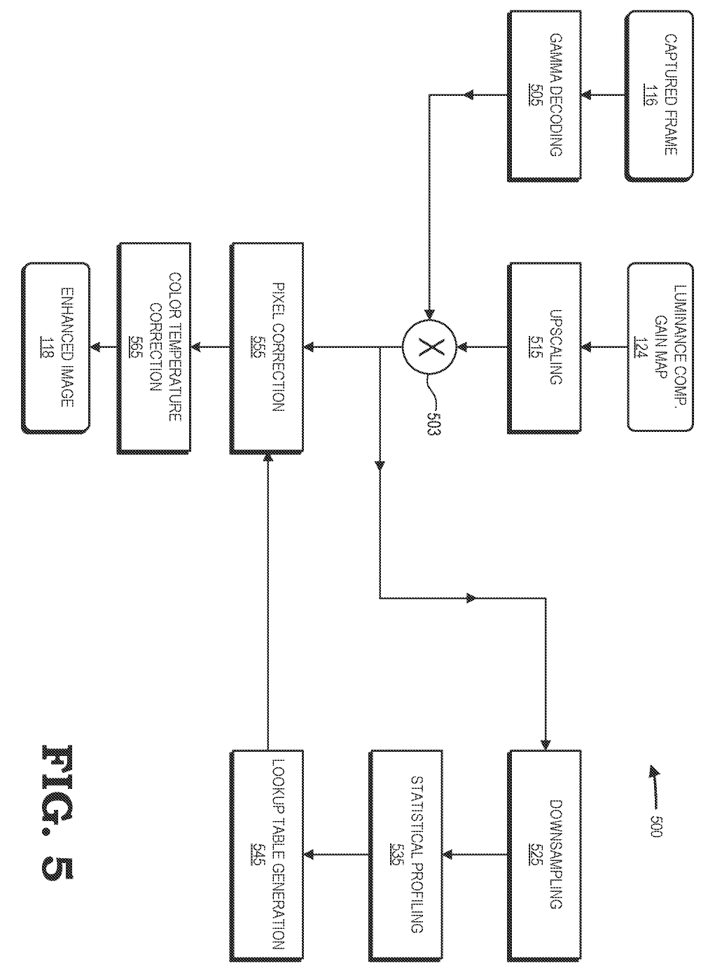

Referring now to FIG. 5, an example postprocessing operation 500 using a neural-network generated luminance compensation gain map is presented, in accordance with embodiments. In some embodiments, example postprocessing operation 500 is implemented at least in part by AU 112. According to embodiments, example postprocessing operation 500 first includes AU 112 performing gamma decoding 505 (e.g., inverse gamma correction) on a captured frame 116. Gamming decoding 505, for example, includes AU 112 transforming the luminance values of the pixels of the captured frame 116 from a gamma space to a linear space based on a predetermined gamma value to produce a frame with gamma-decoded pixels (e.g., gamma-decoded frame). According to some implementations, gamma decoding 505 is performed in circumstances where the captured frame 116 has previously undergone gamma correction. Further, example postprocessing operation 500 includes AU 112 performing upscaling operation 515 on a luminance compensation gain map 124 generated by, for example, trained neural network 122, 200. Upscaling operation 515, for example, includes AU 112 enlarging the luminance compensation gain map 124 to the resolution of captured frame 116 to produce an upscaled luminance compensation gain map. AU 112 then modifies one or more pixels of the gamma-decoded captured frame based on the upscaled luminance compensation gain map. For example, AU 112 multiplies the luminance values of the pixels of the gamma-decoded frame by the corresponding luminance gain compensation values of the upscaled luminance compensation gain map to produce a compensated captured frame. Such multiplication of the pixels of the gamma-decoded frame by the luminance values of the upscaled luminance compensation gain map is represented in FIG. 5 by multiplier 503.

According to embodiments, to help reduce the likelihood of artifacts in a resulting enhanced frame 118, example postprocessing operation 500 further includes AU 112 performing downsampling block 525 during which AU 112 downsamples (e.g., downscales) the compensated captured frame to a predetermined resolution (e.g., a downsampled compensated captured frame). Additionally, example postprocessing operation 500 includes statistical profiling block 535 during which AU 112 determines one or more reference values, for instance, a median luminance value of one or more groups of pixels of the downsampled compensated captured frame. Based on these determined reference values, AU 112 divides the luminance range of the downsampled compensated captured frame into two or more subranges each associated with a corresponding pixel enhancement function such as gamma correction, tone mapping, histogram equalization, contrast enhancement, noise masking, and the like. Further, each pixel enhancement function associated with a subrange is defined by a respective set of values such as a gain value, offset value, gamma value, or the like. As an example, a first determined subrange is associated with a first pixel enhancement function (e.g., gamma correction) as defined by a first set of values and a second determined subrange is associated with a second pixel enhancement function (e.g., gamma correction) as defined by a second set of values, different from the first set of values.

Referring now to lookup table generation block 545, in some embodiments, AU 112 is configured to generate one or more lookup tables that apply the pixel enhancement functions associated with the determined subranges to the pixels of the downsampled compensated captured frame. Such lookup tables, for example, each indicate one or more corresponding modified color component values, luminance values, or both associated with one or more respective luminance values used as an index to lookup tables. For example, for a first luminance value in a first determined subrange, a lookup tables includes one or more corresponding modified color component values, luminance values, or both as modified by a pixel enhancement function associated with the first determined subrange. At pixel correction block 555, based on a luminance value of a pixel of the downsampled compensated captured frame being within a determined subrange, AU 112 applies the pixel enhancement function associated with the subrange to the pixel to modify the color components of the pixel, the luminance value of the pixel, or both. For example, in some embodiments, AU 112 uses one or more lookup tables to apply the corresponding pixel enhancement functions to the pixels of the downsampled compensated captured frame. In other implementations, AU 112 is configured to generate other suitable approximations or representations of the pixel enhancement functions instead of lookup tables. After applying the corresponding pixel enhancement functions, at color temperature block 565, AU 112 applies one or more color temperature correction and lighting adjustment techniques to one or more pixels of the downsampled compensated captured frame to produce an enhanced frame 118 with modified one or more of color temperature, color balance, and lighting intensity, direction, and gradients.

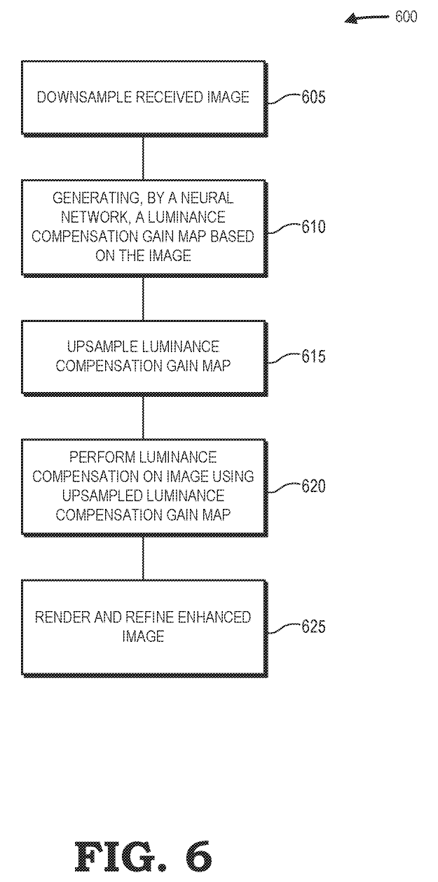

Referring now to FIG. 6, an example method 600 for producing an enhanced image based on a neural-network-generated luminance compensation gain map is presented, in accordance with some embodiments. In embodiment, example method 600 is implemented at least in part by AU 112. At block 605 of example method 600, AU 112 is configured to receive a captured frame 116 from, for example, a capture device 130, and then downsample (e.g., downscale) the captured frame 116 to a predetermined resolution. At block 610, AU 112 uses a trained neural network 122, 200 to produce a luminance compensation gain map 124. Such a trained neural network 122, 200, for example, includes an autoencoder configured to first encode (e.g., using an encoder 232) the downsampled captured frame into a latent representation of the lighting characteristics (e.g., luminance gain values) of the captured frame 116 and then decode (e.g., using a decoder 236) this latent representation to reconstruct the lighting characteristics of the captured frame 116, for example, in the form of luminance compensation gains or other suitable features. According to some implementations, the trained neural network is configured to generate a multichannel feature map and then convert this multichannel feature map to a luminance compensation gain map 124 with a single gain value per pixel location via one or more averaging layers (e.g., averaging layer 238) and modulation layers (e.g., modulation layer 240).

At block 615, AU 112 resizes (e.g., upscales) the luminance compensation gain map 124 to the same resolution as the received captured frame 116. At block 620, AU 112 then modifies one or more luminance values of the captured frame 116 based on the upscaled luminance compensation gain map. For example, AU 112 multiplies the luminance values of one or more pixels of the captured frame 116 by corresponding values indicated in the upscaled luminance compensation gain map. After modifying one or more values of the captured frame 116 based on the upscaled luminance compensation gain map, AU 112 produces a compensated captured image. AU 112 then, at block 625, performs one or more postprocessing operations on the compensated captured image to produce an enhanced frame 118. For example, at block 625, AU performs downsampling block 525, statistical profiling block 535, lookup table generation block 545, pixel correction block 555, color temperature correction block 565, or any combination thereof based on the compensated captured image to produce an enhanced frame 118. After determining the enhanced frame 118, in some embodiments, AU 112 then displays the enhanced frame 118 on, for example, a display 128, stores the enhanced frame 118 in memory 106 or another storage, or both.

In some embodiments, the apparatus and techniques described above are implemented in a system including one or more integrated circuit (IC) devices (also referred to as integrated circuit packages or microchips), such as the AU described above with reference to FIGS. 1-6. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices to perform at least a portion of a process to design or adapt a manufacturing system to fabricate the circuitry. This code can include instructions, data, or a combination of instructions and data. The software instructions representing a design tool or fabrication tool are typically stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based flash memory) or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as flash memory, a cache, random access memory (RAM), other non-volatile memory device or devices, and the like. The executable instructions stored on the non-transitory computer readable storage medium may be in source code, assembly language code, object code, or other instruction format that is interpreted or otherwise executable by one or more processors.

Note that not all the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An accelerator unit (AU), comprising:
one or more processor cores configured to:
generate, by a trained neural network, a compensation map of an image, wherein the trained neural network is configured to receive data representing the image as an input and to provide the compensation map as an output;
modify at least a portion of the image based on the compensation map to produce an enhanced image; and
render the enhanced image.

2. The AU of claim 1, wherein the trained neural network includes an encoder configured to:
produce a latent representation of lighting characteristics of the image based on the data representing the image.

3. The AU of claim 2, wherein the trained neural network further includes a decoder and a residual block disposed between the decoder and the encoder, the residual block configured to:
produce a modified representation of lighting characteristics of the image based on the latent representation of lighting characteristics of the image.

4. The AU of claim 3, wherein the decoder is configured to:
generate two or more feature maps based on the modified representation, wherein each feature map of the two or more feature maps has a corresponding scale.

5. The AU of claim 1, wherein the one or more processor cores are configured to modify the at least a portion of the image by:
applying one or more compensation values indicated in the compensation map to one or more pixel values of the image.

6. The AU of claim 1, wherein the one or more processor cores are configured to:
train a neural network based on a first reference image representing a foreground of an environment and a second reference image representing a background of the environment to produce the trained neural network.

7. The AU of claim 1, wherein the one or more processor cores are configured to:
divide a luminance range of the image into a plurality of subranges, wherein each subrange of the plurality of subranges is associated with a corresponding pixel enhancement function; and
based on a pixel value of a pixel of the image being within a respective subrange of the plurality of subranges, apply the corresponding pixel enhancement function to the pixel.

8. A method comprising:
generating, by a trained neural network, a compensation map of an image, wherein the trained neural network is configured to receive data representing the image as an input and to provide the compensation map as an output;
modifying at least a portion of the image based on the compensation map to produce an enhanced image; and
rendering the enhanced image.

9. The method of claim 8, further comprising:
producing, by an encoder of the trained neural network, a latent representation of lighting characteristics of the image based on the data representing the image.

10. The method of claim 9, wherein the trained neural network further includes a decoder and a residual block disposed between the decoder and the encoder, the method further comprising:
producing, by the residual block, a modified representation of lighting characteristics of the image based on the latent representation of lighting characteristics of the image.

11. The method of claim 10, further comprising:
generating, by the decoder, two or more features maps based on the modified representation, wherein each feature map of the two or more feature maps has a corresponding scale.

12. The method of claim 8, wherein modifying the at least a portion of the image includes:
applying one or more compensation values indicated in the compensation map to one or more pixel values of the image.

13. The method of claim 8, further comprising:
training a neural network based on a first reference image representing a foreground of an environment and a second reference image representing a background of the environment to produce the trained neural network.

14. The method of claim 8, further comprising:
dividing a luminance range of the image into a plurality of subranges, wherein each subrange of the plurality of subranges is associated with a corresponding pixel enhancement function; and
based on a pixel value of a pixel of the image being within a respective subrange of the plurality of subranges, applying the corresponding pixel enhancement function to the pixel.

15. An accelerator unit (AU), comprising:
one or more processor cores configured to:
implement a trained neural network configured to:
generate a latent representation of a captured image; and
based on the latent representation of the captured image, generate a compensation map;
modify at least a portion of the captured image based on the compensation map to produce an enhanced image; and
render the enhanced image.

16. The AU of claim 15, wherein the one or more processor cores are configured to:
divide a luminance range of the captured image into a plurality of subranges, wherein each subrange of the plurality of subranges is associated with a corresponding pixel enhancement function; and
based on a pixel value of a pixel of the captured image being within a respective subrange of the plurality of subranges, apply the corresponding pixel enhancement function to the pixel.

17. The AU of claim 15, wherein the one or more processor cores are configured to:
resize the compensation map; and
modify the at least a portion of the captured image using the resized compensation map.

18. The AU of claim 15, wherein the trained neural network includes:
an encoder configured to extract a plurality of lighting characteristics of the captured image so as to produce the latent representation of the captured image; and
a decoder configured to combine the plurality of lighting characteristics at a plurality of scales to produce a multichannel feature map.

19. The AU of claim 18, wherein the trained neural network is configured to:
combine one or more luminance gain values of the multichannel feature map to produce the compensation map.

20. The AU of claim 15, wherein the trained neural network includes a residual block including one or more convolutional layers.
